(19) United States
(12) Patent Application Publication
(10) Pub. No.: US 2009/0033436 A1
(43) Pub. Date: Feb. 5, 2009

(54) Directional Coupler in Coaxial Line Technology

(75) Inventor: Roland Ahlers, Hoehenkirchen/Siegertsbrunn (DE)

Correspondence Address: LEWIS, RICE & FINGERSH, LC;ATTN: BOX IP DEPT., 500 NORTH BROADWAY, SUITE 2000, ST LOUIS, MO, 63102, US

(73) Assignee: Rohde & Schwarz GmbH & Co. KG

(21) Appl. No.: 10/595,763

(22) PCT Filed: Oct. 27, 2004
(86) PCT No.: PCT/EP04/12146

§ 371 Date: Sep. 25, 2008

(30) Foreign Application Priority Data
Nov. 12, 2003 (DE) 103 52 784.2

(51) Int. Cl. H01P 5/18

(52) U.S. Cl. 333/109; 333/115

(57) ABSTRACT

A directional coupler comprising a first connection for the inlet or outlet of a shaft, a first decoupling connection which is used to decouple a coupled shaft, a second connection for the inlet or outlet of the inlet or outlet shaft from the first connection and a second decoupling connection which is used to decouple the coupled shaft. The first connection and the first decoupling connection are connected to the internal conductor and to the external conductor of a coaxial conductor on the first connection surface thereof, by means of a first network. The second connection and the second decoupling connection are connected to the internal conductor and to the external conductor of the coaxial conductor on the second connection surface thereof, by means of a second network. The coaxial conductor is curved in such a manner that it is arranged in a parallel manner in relation to the first and second connection surfaces thereof, with a planar circuit board containing the first connection, the second connection, the first decoupling connection and/or second decoupling connection.

The invention relates to a directional coupler in coaxial line technology.

Directional couplers are used in high frequency technology for separate measurement of a go-and-return wave in a line. In the end stages of amplifiers, directional couplers are used for example to measure the voltage standing wave ratio. A directional coupler is hereby used selectively in coaxial line technology.

A directional coupler of this type in coaxial line technology is described for example in U.S. Pat. No. 5,926,076. The directional coupler hereby comprises a coaxial line with an inner conductor, a hollow-cylindrical dielectric guided around the inner conductor and a hollow-cylindrical outer conductor which is applied on the casing of the hollow-cylindrical dielectric and a printed circuit board on which the two decoupling units of the directional coupler are essentially applied. Coaxial line and printed circuit board with decoupling units are disposed at an adjustable spacing relative to each other in a housing.

The comparatively high complexity with respect to a mechanical and also electrical connection between the coaxial line and the two decoupling units and the connections thereof via a common spacing, attachment and mounting in a common housing is disadvantageous in this arrangement. Also the specific and efficient discharge of heat produced from the directional coupler circuit by means of resistors and heat discharge bars has a comparatively complex configuration.

The object therefore underlying the invention is to produce a directional coupler in coaxial line technology in which the mechanical and also electrical connection between the coaxial line and the connections of the directional coupler, in particular the decoupling connections, is produced with minimal additional complexity with respect to the technical appliance.

The object of the invention is achieved by a directional coupler in coaxial line technology having the features of claim 1.

The electrical connection between the inner and outer conductor of the coaxial line and the individual connections of the directional coupler is effected at the input and output of the coaxial line via one resistance network respectively.

The mechanical connection between the coaxial line and the individual connections of the directional coupler which are positioned on a planar printed circuit board is produced in that the coaxial line has for example a semicircular or U-shaped bent configuration and hence is aligned parallel to the planar printed circuit board with its two connection faces and hence, via connection lines or resistors which are part of the above-mentioned resistance networks, a comparatively simple mechanical connection between the inner and outer conductor of the coaxial line and the connections of the directional coupler is achieved.

An electrical and mechanical connection produced in this manner between a coaxial line and the connections of a directional coupler represents a minimum cost solution with respect to material and manufacturing complexity.

Advantageous embodiments of the invention are indicated in the dependent claims.

The planar printed circuit board can be configured in SMD technology. In particular the arrangement of the resistors of both resistance networks, which lead the screening and hence the outer conductor of the coaxial line at both ends to earth potential, are absolutely crucial for the characteristic of the directional coupler and can thus be disposed in a relatively flexible manner.

By fitting the coaxial line with ferrites, a usable characteristic of the directional coupler is achieved over several octaves.

The embodiment of the invention is represented in the drawing and is described subsequently in more detail. There are shown:

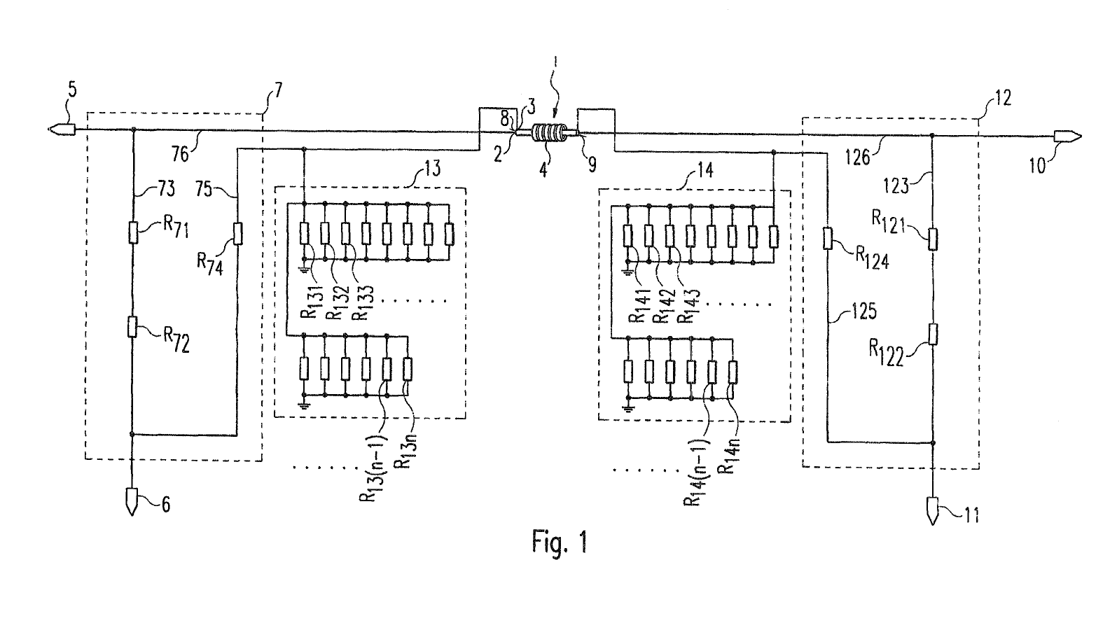

FIG. 1 a circuit diagram of a directional coupler according to the invention in coaxial line technology;

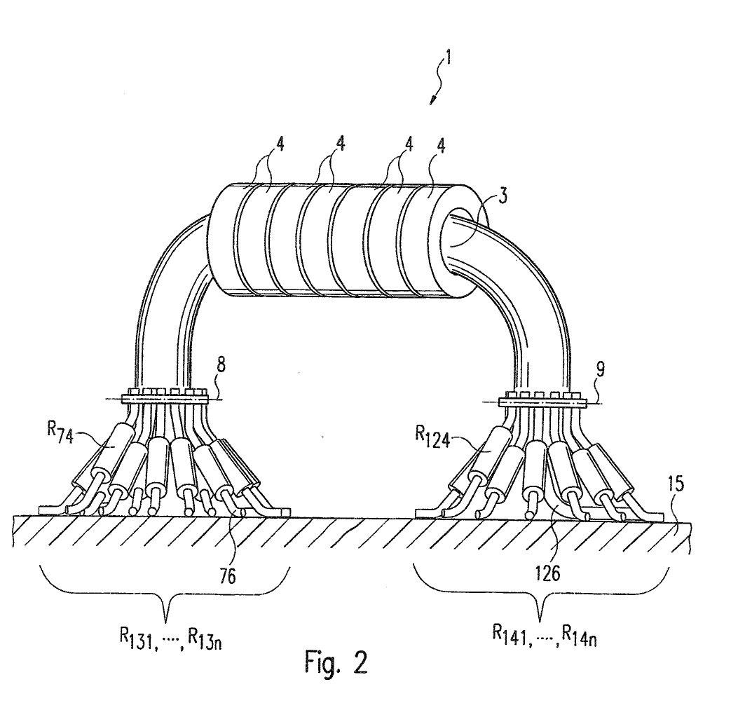

FIG. 2 a side view of a directional coupler according to the invention in coaxial line technology and

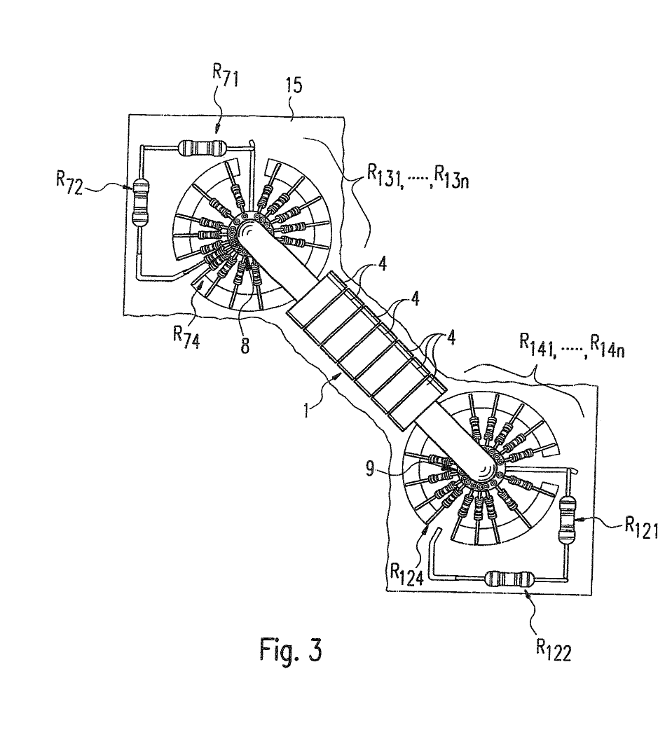

FIG. 3 a plan view of a directional coupler according to the invention in coaxial line technology.

The directional coupler according to the invention in coaxial line technology is described in its embodiment subsequently with reference to FIG. 1 to FIG. 3.

The directional coupler according to the invention in coaxial line technology comprises according to FIG. 1 essentially a coaxial line 1 which comprises an inner conductor 2 and an outer conductor 3 separated via a dielectric. The coaxial line 1 is surrounded on its outer casing by a plurality of aligned ferrite core rings 4.

The coaxial line 1 is connected at its first connection face 8 to the first connection 5 and to the first decoupling connection 6 of the directional coupler via a first resistance network 7 and, at its second connection face 9, to the second connection 10 and to the second decoupling connection 11 via a second resistance network 12 which is symmetrical to the first resistance network 7.

The first resistance network 7 comprises a series connection of a resistor R₇₁ and R₇₂ in the connection line 73 between the first connection 5 and the first decoupling connection 6 and a resistor R₇₄ in the connection line 75 between the outer conductor 3 of the coaxial line 1 and the first decoupling connection 6 and also a direct connection line 76 between the inner conductor 2 of the coaxial line 1 and the first connection 5.

The second resistance network 12 comprises, symmetrically to the first resistance network 7, a series connection of a resistor R₁₂₁ and R₁₂₂ in the connection line 123 between the second connection 10 and the second decoupling connection 11 and a resistor R₁₂₄ in the connection line 125 between the outer conductor 3 of the coaxial line 1 and the second decoupling connection 11 and also a direct connection line 126 between the inner conductor 2 of the coaxial line 1 and the second connection 10.

The outer conductor 3 is led at the first connection face 8 of the coaxial line 1 by a third resistance network 13 to earth potential. The third resistance network 13 comprises a parallel connection of a plurality of low impedance resistors R₁₃₁, R₁₃₂, R₁₃₃, . . . , R₁₃₍ₙ₋₁₎, R₁₃ₙ.

The outer conductor 3 at the second connection face 9 of the coaxial line 1 is led to earth potential by a fourth resistance network 14, which is configured completely symmetrically to the third resistance network 13. The fourth resistance network 14 accordingly comprises a parallel connection of a plurality of low impedance resistors R₁₄₁, R₁₄₂, R₁₄₃, . . . , R₁₄₍ₙ₋₁₎, R₁₄ₙ.

The resistors R₇₁, R₇₂ and R₇₄ of the first resistance network 7 and the resistors R₁₂₁, R₁₂₂, R₁₂₄ of the second resistance network 12 have a higher impedance design than the low impedance resistors R₁₃₁, . . . , R₁₃ₙ of the third resistance network 13 and the low impedance resistors R₁₄₁, . . . , R₁₄ₙ of the fourth resistance network 14.

In side view in FIG. 2 and in plan view in FIG. 3 of the directional coupler according to the invention in coaxial line technology, the semicircular or U-shaped configuration of the coaxial line 1 can be detected. Bending of the originally linear coaxial line 1 into the circular or U-shaped configuration according to FIG. 2 or FIG. 3 is possible by using the semi-rigid technology in the inner conductor 2, dielectric and outer conductor 3 of the coaxial line 1.

In FIG. 2 or FIG. 3, likewise the conical arrangement of the resistors R₁₃₁, . . . , R₁₃ₙ of the third resistance network 13 or of the resistors R₁₄₁, . . . , R₁₄ₙ of the fourth resistance network 14 between the outer conductor 3 of the coaxial line 1 and the planar printed circuit board 15 can be detected, which contains the first and second connection 5 and 10 or the first and second decoupling connection 6 and 11, further components which are disposed for example in SMD technology. All the resistors R₁₃₁, . . . , R₁₃ₙ and also R₁₄₁, . . . , R₁₄ₙ are, as is evident in FIG. 2 or FIG. 3, soldered onto the printed circuit board.

In FIG. 2, finally also the connection line 76 or 126 from the inner conductor 2 of the coaxial line to the first connection 5 or to the second connection 10 of the directional coupler and also the resistor R₇₄ of the first resistance network 7 or the resistor R₁₂₄ of the second resistance network 12, which are likewise configured in conventional technology and are both aligned in the conical arrangement of the resistors R₁₃₁, . . . , R₁₃ₙ of the third resistance network 13 or of the resistors R₁₄₁ . . . R₁₄ₙ of the fourth resistance network 14, can be detected.

In the plan view in FIG. 3, finally the resistors R₇₁ and R₇₂ of the first resistance network 7 and the resistors R₁₂₁ and R₁₂₂ of the second resistance network 12 can be detected, which are also configured in conventional technology and soldered on the planar printed circuit board 15 which is produced in the embodiment in SMD technology.

The topology of the first, second, third and fourth resistance network 7, 12, 13 and 14, the suitable parameterisation of the associated resistors R₇₁, R₇₂, R₇₄, R₁₂₁, R₁₂₂, R₁₂₄ and R₁₃₃, . . . , R₁₃ₙ and also R₁₄₁, . . . , R₁₄ₙ and the spatial arrangement in particular of the resistors R₇₄, R₁₂₄, R₁₃₁, . . . , R₁₃ₙ and R₁₄₁, . . . , R₁₄ₙ establish the directional sharpness and coupling attenuation of the directional coupler. By suitable choice of topology, parameterisation and spatial arrangement of the resistors, it can be ensured that, at the first decoupling connection 6, a constructive positive superimposition is decoupled from the go-and-return waves between the first connection 5 and first connection face 8 of the coaxial line 1 and, at the second decoupling connection 11, a mutual obliteration of the two waves, which are decoupled from the go-and-return waves between the second connection 10 and second connection face 9 of the coaxial line 1, is achieved.

In this way, a broadband directional coupler can be produced without great complexity for applications in particular with broadband amplifiers, for example between 30 and 500 MHz.

The invention is not restricted to the represented embodiment. The described elements can be combined with each other in any manner within the scope of the invention.

1.-8. (canceled)

9. A directional coupler comprising:
a first connection to input or output a wave and a first decoupling connection to decouple a coupled wave, both of said first connection and said first decoupling connection being connected via a first network to an inner conductor and an outer conductor of a coaxial line at a first connection face; and
a second connection to input or output said input or output wave from said first connection and a second decoupling connection to decouple a coupled wave, both of said second connection and said second decoupling connection connected via a second network to said inner conductor and to said outer conductor of said coaxial line at a second connection face;
wherein, said coaxial line is bent in such a manner that said first connection face and said second connection face are aligned generally parallel to a generally planar printed circuit board; said circuit board including at least one of said first connection, said second connection, said first decoupling connection, or second decoupling connection.

10. The directional coupler of claim 9 wherein, said first network and said second network are resistance networks.

11. The directional coupler of claim 10 wherein resistors forming said first and said second resistance networks are components soldered onto said circuit board in SMD technology.

12. The directional coupler of claim 10 wherein, said outer conductor of said coaxial line is led to earth potential at said first connection face via a third network and at said second connection face by a fourth network.

13. The directional coupler of claim 12 wherein, said third network and said fourth network are resistance networks.

14. The directional coupler of claim 13 wherein resistors forming said first, second, third and fourth resistance networks are components soldered onto said circuit board in SMD technology.

15. The directional coupler of claim 13 wherein both of said third and said fourth networks are low impedance networks.

16. The directional coupler of claim 13 wherein said coaxial line is bent in a semicircular shape.

17. The directional coupler of claim 16 wherein:
said coaxial line is mechanically and electrically connected to said circuit board at said first connection face via a first connection conductor connected to said inner conductor and via first conically disposed resistors connected to said outer conductor, said first connection conductor and said first conically disposed resistors being a part of said first network or said third network; and
said coaxial line is mechanically and electrically connected to said circuit board at said second connection face via a second connection conductor connected to said inner conductor and via second conically disposed resistors connected to said outer conductor, said second connection conductor and said second conically disposed resistors being a part of said second network or said fourth network

18. The directional coupler of claim 13 wherein said coaxial line is bent in a U-shape.

19. The directional coupler of claim 18 wherein:
said coaxial line is mechanically and electrically connected to said circuit board at said first connection face via a first connection conductor connected to said inner conductor and via first conically disposed resistors connected to said outer conductor, said first connection conductor and said first conically disposed resistors being a part of said first network or said third network; and
said coaxial line is mechanically and electrically connected to said circuit board at said second connection face via a second connection conductor connected to said inner conductor and via second conically disposed resistors connected to said outer conductor, said second connection conductor and said second conically disposed resistors being a part of said second network or said fourth network

20. The directional coupler of claim 9 wherein said coaxial line is bent in a semicircular shape.

21. The directional coupler of claim 9 wherein said coaxial line is bent in a U-shape.

22. The directional coupler of claim 9 further comprising at least one ferrite ring made of a ferrite material which surrounds said coaxial line.

23. The directional coupler of claim 22 wherein said at least one ferrite ring comprises a plurality of aligned ferrite rings encasing said coaxial line.
